(19) United States
(12) Patent Application Publication
(10) Pub. No.: US 2012/0014273 A1
(43) Pub. Date: Jan. 19, 2012

(54) An Apparatus and Method for Voice Call Continuity

(75) Inventors: Dejana Notton, London (GB); Richard Collin, London (GB); Victoria Turner, London (GB)

(73) Assignee: NOKIA CORPORATION, Espoo (FI)

(21) Appl. No.: 13/125,504

(22) PCT Filed: Oct. 21, 2009
(86) PCT No.: PCT/IB2009/054657

§ 371 Date: Aug. 10, 2011

(30) Foreign Application Priority Data
Oct. 21, 2008 (GB) 0819332.8
Dec. 22, 2008 (GB) 0823365.2

(51) Int. Cl. H04L 12/66; H04W 76/00; H04L 12/26

(52) U.S. Cl. 370/252; 370/352; 370/328

(57) ABSTRACT

A mobile device having an operating system which includes a communications framework having a voice call continuity convergence layer. The status of the circuit switched and packet switched parts of the network are reported to the convergence layer which decides which part of the network to connect to based on network status and pre-stored profiles.

An example of the present invention relates to an apparatus having a communications framework which is arranged to enable voice call continuity between a circuit switched network and a packet switched network. An example of the present invention also relates to a method of operation of such an apparatus.

### BACKGROUND TO THE INVENTION

Third generation (3G) mobile phone networks provide access to the PSTN and the Internet using a combination of circuit switched (CS) and packet switched (PS) network components. The circuit switched part of the network has its roots in the 2G GSM infrastructure. However, the majority of voice calls placed over a 3G network are still handled by the CS part of the network. The CS domain is connected directly to the PSTN.

The evolution of 2G networks to 2.5G brought the introduction of a PS domain, which has developed further with 3G networks. The PS domain enables IP traffic to move between a mobile device, connected to mobile base station, and the Internet. In 2.5 G communications, the PS domain is the GPRS (General Packet Radio Service). The PS domain is also connected to the PSTN and enables VoIP calls. Rather than using the CS domain part of the network, user equipment (UE) may connect through to the PSTN using the IP part of the network. The part of the PS domain which enables this is the IP Multimedia Subsystem (IMS).

It is also possible for UEs to connect to 3G services via WLANs. This gives the opportunity for UEs to connect to PLMNs (Public Land Mobile Networks) via WLAN access points. So, for example, if a UE is unable to connect to a PLMN, but a WLAN access point is available, the UE can still make a call. WLANs are connect to the 3G network via the IMS. All WLAN traffic is IP traffic.

When a user moves around, a connection may be transferred from a WLAN access point to a 3G Node B, and vice versa, depending on signal strength or network conditions. This is called Voice Call Continuity (VCC). If a call is transferred from the 3G CS domain to the 3G IMS (while still being routed through a 3G Node B), this is also referred to as VCC.

### SUMMARY OF EXAMPLES OF THE INVENTION

An example of the invention provides an apparatus comprising: at least one processor; and at least one memory including computer program code, wherein the at least one memory and the computer program code are configured to, with the at least one processor, cause the apparatus to: establish a communications framework, the communications framework being configured to establish connections to at least one communications network; wherein the communications framework comprises a voice call continuity layer configured to decide whether to establish voice calls over a circuit switched part of said at least one communications network or a packet switched part of said at least one communications network and being configured to decide when to transfer a voice call from one part of the network to another part, wherein said voice call continuity layer being further configured to make said decisions based on network availability information and/or pre-stored preferences.

In an example of the invention, the communications framework may further comprise a packet switched communication layer configured to monitor the availability of the packet switched part of the at least one communications network and to report network availability information to the voice call continuity layer.

In an example of the invention, the communications framework may further comprise a circuit switched communication layer configured to monitor the availability of the circuit switched part of the at least one communications network and to report availability information to the voice call continuity layer.

In an example of the invention, each layer of the communications framework may include a data plane, configured to transport data, a control plane, configured control connections, and a management plane, configured to make decisions.

In an example of the invention, each layer of said communications framework may include a data entity, in said data plane, at least one control entity, in said control plane, and a management entity, in said management plane.

In an example of the invention, the voice call continuity layer management entity may be configured to make decisions based on said communication network availability information received from said packet switched and circuit switched communications layers.

In an example of the invention, the voice call continuity layer at least one control entity may be configured to control connections to said at least one network.

In an example of the invention, the control entity may comprise a main control entity configured to control connections to said at least one network, and a session control entity, configured to control individual voice sessions.

In an example of the invention, the voice call layer data entity in said data plane may be configured to synchronise packet switched and circuit switched audio data during call transfer.

In an example of the invention, the circuit switched and packet switched layer management entities may be configured to report the availability of their respective parts of said at least one communications network to said voice call continuity layer management entity.

In an example of the invention, the voice call continuity layer management entity may be further configured to inform said at least one voice call continuity layer control entity of said decisions.

In an example of the invention, the communications framework may include a data store for storing said preferences and said voice call continuity layer management entity is further configured to make said decisions based on said preferences.

In an example of the invention, the communications framework may further comprise a telephony interface, configured to provide clients with access to voice call communications.

In an example of the invention, the apparatus may further comprise a radio.

In an example of the invention, the radio may be a WCMDA radio and said communications network may be a 3G network.

In an example of the invention, the apparatus may further comprise a WLAN radio.

In an example of the invention, the pre-stored preferences may include information relating to radio connection availability and signal strengths.

A further example of the invention provides a method comprising: initiating a voice call; deciding whether to establish the voice call in a circuit switched part of at least one communications network or a packet switched part of said at least one communications network, based on network availability and/or pre-stored preferences; and establishing a voice call according to said decision; wherein said decision is made by a voice call continuity layer which is part of a communications framework, the framework configured to establish connections to said at least one communications network.

A further example of the invention provides a method comprising: monitoring the availability of circuit switched and packet switched parts of at least one communications networks when a voice call is active; determining when pre-stored call transfer parameters are met; and causing said voice call to be transferred from the circuit switched to the packet switched network, or vice versa; wherein monitoring availability is done by a communications framework, the framework configured to establish connections to said at least one communications network, and determining when pre-stored call transfer parameters are met is done by a voice call continuity layer, which is part of said communications framework.

A further example of the invention provides an apparatus comprising: means for establishing a communications framework, the communications framework being configured to establish connections to at least one communications network; wherein the communications framework comprises a voice call continuity layer being configured to decide whether to establish voice calls over a circuit switched part of said at least one communications network or a packet switched part of said at least one communications network and being configured to decide when to transfer a voice call from one part of the network to another part, and said voice call continuity layer being further configured to make said decisions based on network availability information and/or pre-stored preferences.

A further example of the invention provides a network for providing circuit switched and packet switched voice communications, the network comprising mobile telephone communications access points, WLAN access points and a plurality of apparatus in accordance the apparatus described above.

A further example of the invention provides a computer program product comprising a computer-readable medium bearing computer program code embodied therein for use with a computer, the computer program code comprising: code for establishing a communications framework, the communications framework being configured to establish connections to at least one communications network; wherein the communications framework comprises a voice call continuity layer being configured to decide whether to establish voice calls over a circuit switched part of said at least one communications network or a packet switched part of said at least one communications network and being configured to decide when to transfer a voice call from one part of the network to another part, and said voice call continuity layer being further configured to make said decisions based on network availability information and/or pre-stored preferences.

A further example of the invention provides a computer program, comprising: code for establishing a communications framework, the communications framework being configured to establish connections to at least one communications network; wherein the communications framework comprises a voice call continuity layer being configured to decide whether to establish voice calls over a circuit switched part of said at least one communications network or a packet switched part of said at least one communications network and being configured to decide when to transfer a voice call from one part of the network to another part, and said voice call continuity layer being further configured to make said decisions based on network availability information and/or pre-stored preferences.

A further example of the invention provides a computer readable medium storing the computer program described above.

A further example of the invention provides a computer-readable medium encoded with instructions that, when executed by a computer, perform the method described above.

Other features of examples of the present invention are defined in the appended claims. Features and advantages associated with examples of the present invention will be apparent from the following description of the examples of the invention.

### BRIEF DESCRIPTION OF THE DRAWINGS

Examples of the invention will now be described in more detail, by way of example, with reference to the accompanying drawings in which:

FIG. 1 is a schematic diagram of the components of a mobile communications device in accordance with an example of the present invention;

FIG. 2 is a schematic diagram of a communications framework loaded on the device shown in FIG. 1, in accordance with an example of the present invention;

FIG. 3 is a further schematic diagram of the communications framework shown in FIG. 2;

FIG. 4 is yet a further schematic diagram of the communications framework shown in FIG. 2;

FIG. 5 is a communications network;

FIG. 6 is a flow chart showing an operation of the device shown in FIG. 1 in accordance with an example of the present invention; and

FIG. 7 is a flow chart showing a further operation of the device shown in FIG. 1 in accordance with an example of the present invention.

### DETAILED DESCRIPTION OF EXAMPLES OF THE INVENTION

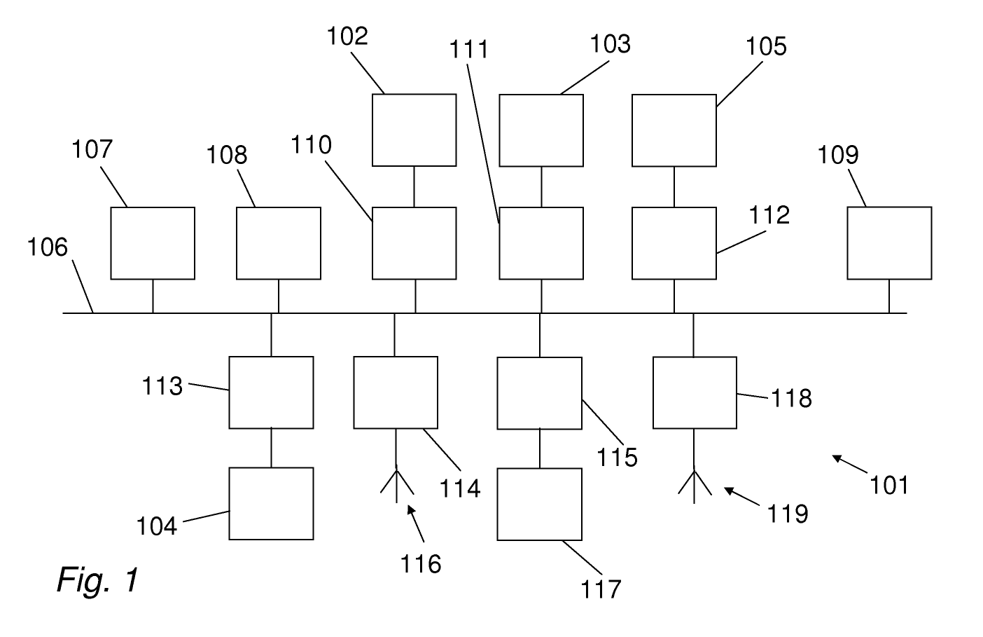

FIG. 1 is a schematic diagram showing the components of a mobile communications device 101, also referred to as user equipment, in an embodiment. In the example of FIG. 1, the components of the mobile device 101 include an earphone 102, a microphone 103, a keypad 104 and a display 105. In this example, the keypad 105 enables a user to enter information into the mobile device 101 and instruct the mobile device to perform the various functions which it provides. For example, a user may enter a telephone number, or select another mobile device from a list stored on the mobile device 101, as well as perform functions such as initiating a telephone call.

The mobile device 101 may, in an example embodiment, also include a system bus 106 to which the components are connected and which allows the components to communicate with each other. In this example, the components are shown to communicate via a single system bus 106. However, in another example the mobile device may include several buses to connect the various components. In an example embodiment, the device also includes an application processor 107, a baseband processor 108, memory 109, an earphone controller 110, a microphone controller 111, a display controller 112, a keyboard controller 113, a WCDMA radio 114 and a storage device controller 115. The application processor 107 is for running an operating system and user applications, for example. The baseband processor 108 is for controlling a telephony stack, for example. In this example, the WCDMA radio 114 is also connected to an antenna 116. In this example, the mobile device 101 is arranged to communicate, via WCDMA radio 114, with a base station of a WCDMA mobile phone network (not shown). The storage device controller 115 may be connected to a storage device 117, for example, which may be an internal hard drive or a removable storage device such as a flash memory card. The mobile device 101 may also include an IEEE 802.11 radio 118, for example, which may be connected to an antenna 119.

In the example of FIG. 1, the mobile device 101 may be arranged to establish calls with 3G and WLAN networks. For example, the device may establish circuit switched (CS) connections via the CS domain part of the 3G network. The device may also establish data connection using IP protocols over the packet switched (PS) part of the 3G network. Additionally, in this example, the device may establish a connection via a WLAN to the IMS (IP Multimedia Subsystem) part of a 3G network. The details of these networks, in this example, and the manner in which connections are established with them will be described in more detail below.

In the example of FIG. 1, the mobile device 101 also includes an operating system (OS) which is stored in ROM which is part of memory 109. In this example, the operating system may include a communications framework which provides support for telephony and IP sessions over different physical bearers. The communications framework provides, in this example, a service mobility mechanism.

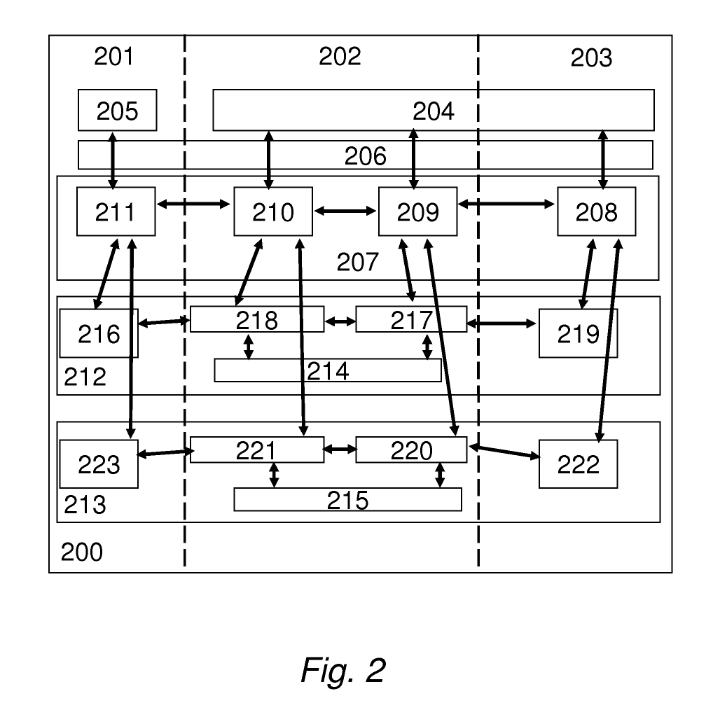

In the example of FIG. 2, the communications framework may be used to implement the VCC convergence framework 200. In this example, the communications framework may be represented by three separate planes. For example, these planes may be the data plane 201, the control plane 202, and the management plane 203. This architecture may also be used for voice communications, whether communications are CS or PS based. This is because, in this example, CS and PS voice calls both have a data part (the audio data), a control part (the signalling used to establish a voice connection) and a management part (the managing unit that controls the signalling connection once it is established).

In an example embodiment, the VCC framework 200 may be implemented through several horizontal layers, or access points, stacked on top of each other. For example, towards the top of the VCC framework is the VCC layer and towards the bottom of the stack are a CS layer and an IMS layer. In this example, the VCC layer directs all requests to either the CS or IMS layer. The VCC layer may make, for example, the decision on which layer to direct requests to. This may be based on bearer availability, user/operator settings and preferences, and/or any policies that might be present in the system. In this example, the VCC layer is also responsible for making the decisions on when and how to perform seamless voice call handovers between different domains. This may also include any communications with the network required to trigger and perform the handovers.

In an example embodiment, the CS layer of the stack provides the VCC framework 200 with a connection to the CS network. In this example, it may also perform voice call establishment over a GSM/WCDMA CS bearer and controls established voice call connections. The CS layer may use, for example, CS call control APIs to achieve this. In this example, the CS layer also deals with any transfer of the audio data between the baseband processor and the application processor that might be required later for the synchronisation of the voice stream during the handover.

In an example embodiment, the IMS layer of the stack may be arranged to register to an IMS network and to allow establishment of an IMS voice session using the SIP and RTP protocols. In this example, the IMS layer uses the services of a SIP stack to establish a SIP session with an IMS network. In this example, the IMS layer uses the RTP protocol to transfer the RTP voice packets in both directions between the network and the multimedia framework on the application processor.

These components, in an example embodiment, will be described in more detail below.

In the example of FIG. 2, at the top of the communications stack are the telephony convergence APIs 204 and the multimedia APIs 205. In this example, the telephony convergence APIs 204 provide access to voice communications via a set of generic APIs. The multimedia APIs 205 may provide, for example, access to the audio stream which is produced by lower layers of the framework. In this example, these APIs provide access to the lower layers of the stack through the ESOCK server 206. In this example, telephony convergence API requests are passed to the VCC framework 200 through the ESOCK communications server 206.

In an example, embodiment, access to the convergence functionality of the VCC framework 200 is provided through the telephony convergence API 204. In this example, the telephony convergence API 204 allows applications to connect to a particular type of network (e.g. IMS or CS). Alternatively applications can choose the default network type, which would be selected by the VCC framework 200 based on availability, policy or settings. In this example, the telephony convergence API 204 also allows applications to establish a voice connection over that network and lets the underlying VCC framework deal with mobility of that voice connection. For example, applications may be notified when a handover occurs, but no action is required by applications, as this would be done by the underlying VCC framework 200. Finally, the telephony convergence API 204 may allow access to the preferences and settings for applications to access or modify, if they have the required access rights. In this example, telephony convergence API 204 requests coming from applications are routed by the communications framework to the top layer or access point in the VCC stack. In this example, this is the VCC layer or access point.

As noted in the above example, the VCC stack may be divided vertically into three planes: the management, control and data planes. Each layer in the stack may be implemented through a number of nodes, or providers, in the management, control and data plane.

In an example embodiment, the management plane 203 of each layer includes a management node responsible for storing policies and profiles, and for monitoring bearer mobility notifications from management nodes of lower layers of the stack. In an example, management nodes make decisions about how and when to set up connections. They may also instruct control plane nodes accordingly. In this example, within the control plane 202 of each layer, connections to the network are controlled by main control node. In this example, the main control nodes establish radio connections based on decisions made and policies stored in the management plane. Each remote end connection (i.e. a call in the circuit switched domain or a voice session in the IMS domain) may be represented as a session control node, which is also part of the control plane 202, for example. In this example, the session control node manages these individual sessions based on commands received from the main control node. There may be a one-to-one mapping between the session control node and the remote end connection, whereas there may be a one-to-many relationship between the main control node and the session control node. The details of each of these entities, in an example, are described in more detail below.

In an example embodiment, below the telephony convergence APIs 204 and the multimedia APIs 205 lies the VCC layer or access point 207. As noted in the above example, the VCC framework 200 is implemented as a stack with the VCC layer on top of the CS and IMS layers. In this example, the management plane 203 includes the convergence management node 208. In this example, the convergence management node 208 is used to decide which bearer to use when multiple bearers are available. Such decisions may be based on the pre-stored profiles and policies and on network availability, for example. In this example, the convergence management node 208 is also used to store any bearer-type dependant logic that might be required for generic call control. The convergence management node 208 may also be used to store any bearer mobility logic that can be used to provide VCC between different network domains. In this example, the control plane 202 includes the convergence main control node 209 and the convergence session control node 210. In this example, the convergence main control node 209 is used for signalling and to establish and control all connections. In this example, the convergence session control node 210 is used to establish and control individual voice sessions. In this example, the control plane 202 is responsible feeding audio data from the networks to a multimedia framework. In this example, the control plane is also responsible for signalling events to the multimedia framework allowing it to deal with synchronisation of the CS audio and PS (RTP) audio data. In this example, the convergence data flow 211 may be responsible for handling the CS audio and PS (RTP) audio data. For example, this enables the seamless handover of the user audio data between the CS and IMS domains.

In an example embodiment, as noted above, the management plane 203 is used for decision making, storing policies and configuration provisioning. In this example, the control plane 202 is used to establish and control the stack based on the instructions from the management plane 203. In this example, the data plane 201 is used to transport the data.

In an example embodiment, the VCC layer 207 makes decisions on which underlying technology to use based on pre-stored profiles, policies and/or network availability. For example, it uses the services of the bearer availability framework to make a decision on which bearer to use. Similarly, it may use the service/bearer mobility framework to perform a seamless handover of a voice call from one domain to another. In this example, the convergence management node 208 may be responsible for monitoring the service/bearer availability of the management nodes in the CS and IMS layers below. In this example, the management node 208 of the VCC layer makes decisions on which bearer to use when multiple bearers are available. As already mentioned in previous examples, such decisions may be based on pre-stored preferences, settings and on network availability. In this example, the management node 208 of the VCC layer 207 is also used to store any bearer mobility logic that is required to perform VCC between different network domains. In this example, the convergence main control node 209 interfaces with the convergence management plane node 208 and is responsible for connecting to a particular network e.g. an IMS network or a CS network. In this example, the convergence session control node 210 is used to establish and control a particular connection channel with that network i.e. an individual voice session established over that network. The control plane 202 may also be responsible, for example, for signalling events to the multimedia framework to enable any synchronisation of the CS audio and PS (RTP) audio data in the multimedia framework. In this example, this enables the seamless handover of the audio data between the CS and IMS domains. In this example, the control plane 202 is responsible for controlling the data plane 201 which is responsible transferring audio data between the network to the multimedia framework. In this example, the VCC data plane node 211 is responsible for allowing the flow of the CS audio and PS (RTP) audio data.

In an example embodiment, the VCC framework 200 also includes a CS layer 212 and an IMS layer 213. These layers may also be referred to as access points. In this example, the VCC layer 207 is stacked on top of the CS and IMS layers. In this example, the CS layer 212 is arranged to connect to a CS network and performs voice call establishment over a GSM/WCDMA CS bearer. The CS layer 212 may use the CS telephony server 214 to provide a connection to the CS network and to gain access to voice call services. The CS telephony server 214 connects to baseband radio services, for example, as will be described below. In this example, the IMS layer 213 is arranged to connect to an IMS network and to allow for voice sessions to be established using SIP and RTP protocols 215.

In an example embodiment, the VCC layer 207 makes a decision as to whether to direct requests from the application to either the CS layer 212 or the IMS layer 213, depending on bearer availability, user/operator settings and preferences, and/or pre-stored policies. For example, the settings and policies may be stored on the mobile device 101 and accessible by the VCC convergence management node 208.

In this example, bearer availability is reported to the VCC management node 208 by respective lower layer management nodes. In this example, the CS and IMS management nodes are responsible for reporting the availability of their own bearers and network status to the VCC management node 208. This enables the VCC management node 208 to make any bearer mobility and handover decisions, for example. The handover and mobility decisions may, for example, be made within the VCC convergence management node 208. In this example, the decisions are then passed to the control plane 202, which is also responsible for notifying the multimedia framework of any events required to synchronise the multiple audio streams from both the CS and PS domains during a handover. In this example, the management node 208 is also responsible for making requests to the network to allow for VCC call anchoring and domain transfer.

As noted in above examples, the CS layer 212 may be responsible for establishing a connection to a CS network and for establishing voice channels (i.e. calls) over a GSM/WCDMA CS bearer. In this example, the management plane 203 of the CS layer 212 includes a CS management node 219 and its main responsibility is to report any registration or network status changes in the CS network (i.e. CS bearer availability) to the VCC convergence management node 208 of the VCC layer 207. In this example, the control plane 202 of the CS layer 212 consists of two separate control nodes. In this example, the CS main control node 217 is responsible for registering to a CS network. In this example, the CS session control node 218 is responsible for establishing a particular voice channel with that network. In this example, the CS main control node 217 of the CS layer is responsible for registering and establishing a connection to a CS network. It may also control voice channels (i.e. calls) with the CS network established by the CS session control node 218. In this example, each remote end connection (i.e. a voice call in the CS domain) is represented and controlled by the CS session control node 218. In this example, the CS session control node 218 establishes and controls an individual CS session. There may be a one-to-one relationship between the session control node 218 and a voice channel established with the network, for example. In this example, the data plane 201 of the CS layer 212 includes a CS audio data node 216 which provides access to CS audio data.

In an example embodiment, the IMS layer 213 provides a connection to an IMS network and allows establishment of voice calls over an IMS session using the SIP and RTP protocols. The IMS layer 213 may use, for example, the services of the SIP stack 215 to establish a SIP connection to an IMS network and to ensure that the RTP packets are streamed between the RTP flow and the multimedia framework. For example, in a similar manner to the CS layer 212, the connection to the IMS network is modelled as the IMS main control node 220 and each remote end connection (i.e. a voice session in the IMS domain) is represented as an IMS session control node 221. In this example, the IMS main control node 220 is responsible for registering and establishing a connection and registering to an IMS network. In this example, the IMS session control node 221 is arranged to establish and control an IMS session to an IMS network. Therefore, in this example, in the IMS layer 213, the control plane for an IMS session will be implemented by the two control nodes 220 and 221.

In an example embodiment, the management plane 203 of the IMS layer 213 is represented by the IMS management node 222. A purpose of IMS management node 222 is to report IMS network availability changes to the convergence management node 208, for example. In this example, the IMS management node 222 decides the actions of the IMS main control node 220 based on pre-stored user/operator network preferences or on pre-stored SIP/SDP profiles. The SIP/SDP profiles may be stored in a data store (such as a database or a file store). In an example, when a connection is being made, the IMS management node 222 uses these pre-defined profiles to retrieve the data required for establishing an IMS session.

In an example embodiment, the IMS main control node 220 is responsible for connecting to the SIP stack 215, and loading the default IMS session control node 221 to register with the IMS network. In this example, the control session node 221 represents and controls a communication channel over an established IMS connection to the network. In the IMS network, the IMS session represents a SIP session which is used for signalling to establish a multimedia session, for example. In this example, the IMS session control node 221 is responsible for controlling IMS signalling using the SIP protocol. In this example, once the signalling session is established with the network, multi-media information can flow through the IP network using the RTP protocols, which are used to deliver real time information (audio or video) across a packet connection using IP.

In an example embodiment, IMS packets are processed by the data plane 201, which may be represented by the RTP data node 223. In this example, the RTP data node 223 controls data transfer with the network using RTP/UDP. In this example, the RTP data node 223 is controlled from the control plane by the dedicated IMS session control node 221 for that particular IMS session (e.g. a VoIP call). In this example, the IMS session control node 221 provides control over the incoming/outgoing audio RTP streams by starting and stopping the RTP data node 223 as required.

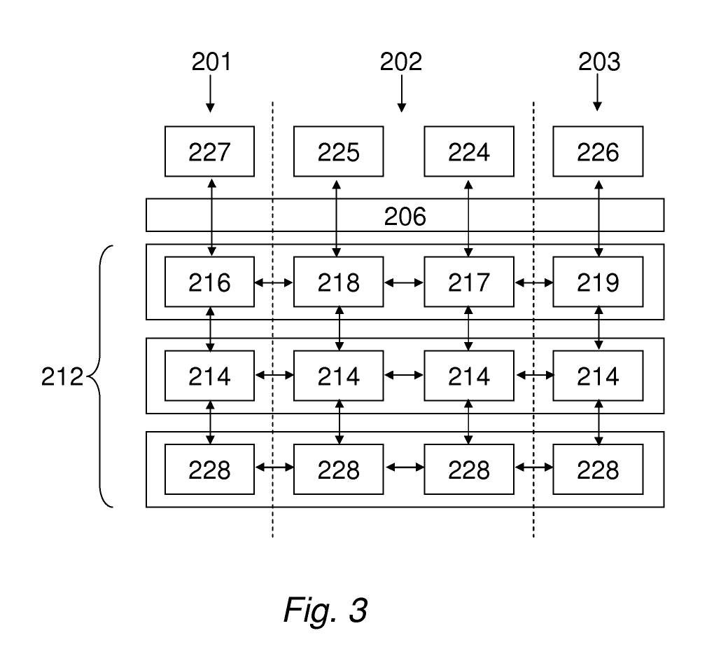

FIG. 3 shows a more detailed logical diagram of the VCC convergence framework 200, in an example embodiment. In this example, the diagram shows a CS implementation and omits the VCC layer 207 for clarity. In this example, the VCC framework also offers a set of generic, technology agnostic APIs used to establish a voice session over any underlying access technology. In this example, when a application uses the telephony convergence APIs 204 to initiate a session, the session can be routed over different types of network. For example, the session can be routed over an IMS network rather than a GSM/UMTS circuit switched network without the client being aware of the type of bearer which is being used. In this example, this means that the telephony convergence framework supports what are termed as “bearer agnostic calls”.

In an example embodiment, the telephony convergence APIs 204 include a telephony service 224. In this example, the telephony service 224 communicates with the CS main control node 217. In this example, the name “Service” signifies a connection to a network. In this example, the telephony convergence APIs 204 also include a telephony session 225 which represents a remote end connection. In this example, this entity communicates with the CS session control node 218. In this example, the name “Session” is used because this interface is ultimately intended to be extensible to support bearer agnostic calls.

In an example embodiment, the telephony convergence APIs 204 includes telephony system information 226 which is for connection to the CS management node 219. It may be used to retrieve the telephony settings, attributes and policies. In this example, the multimedia APIs 205 include a socket 227 which is for extraction of the audio stream provided by the CS or IMS domain. In this example, the CS telephony server 214 is also referred to as ETel which loads appropriate telephony modules (TSYs). In this example, the CS telephony server 214 connects to the baseband radio services 228

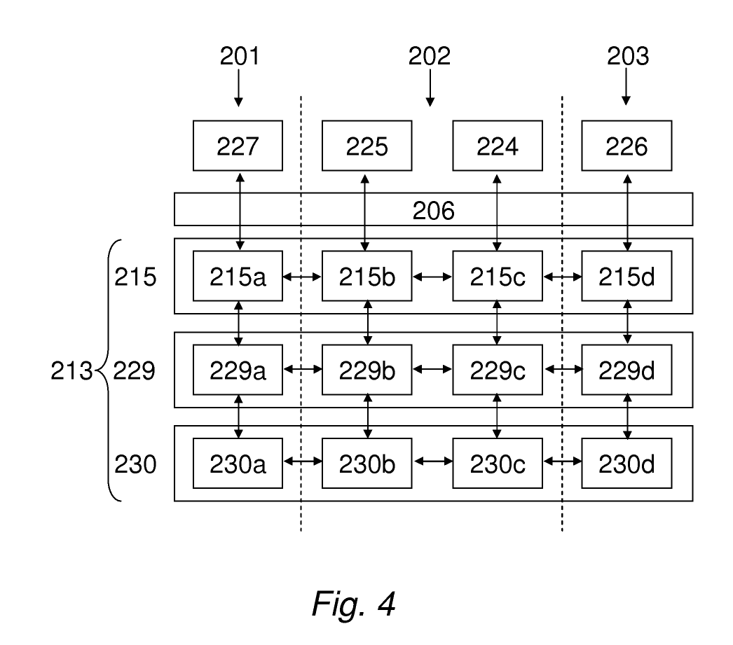

FIG. 4 is equivalent to FIG. 3 but shows the IMS stack within the VCC convergence framework 200 rather than the CS stack, in an example embodiment. In the example of FIG. 4, both the VCC layer 207 and the top sub-layer of the IMS layer 213 are omitted. The Figure shows representations of the IP layer 229 and the PDP context 230. In this example, also shown are RTP protocol 215a, SIP protocols 215b and 215c and the IMS management node 222. FIG. 4 also shows an example in which the IP protocol implementation consisting of a number of nodes which are arranged into the three planes: the management plane (229a), control plane (229b and 229c) and data plane (229a). In this example, the PDP protocol implementation is shown as a layer below in the stack which is also implemented in the three planes: data (230a), control (230b and 230c) and management (230d).

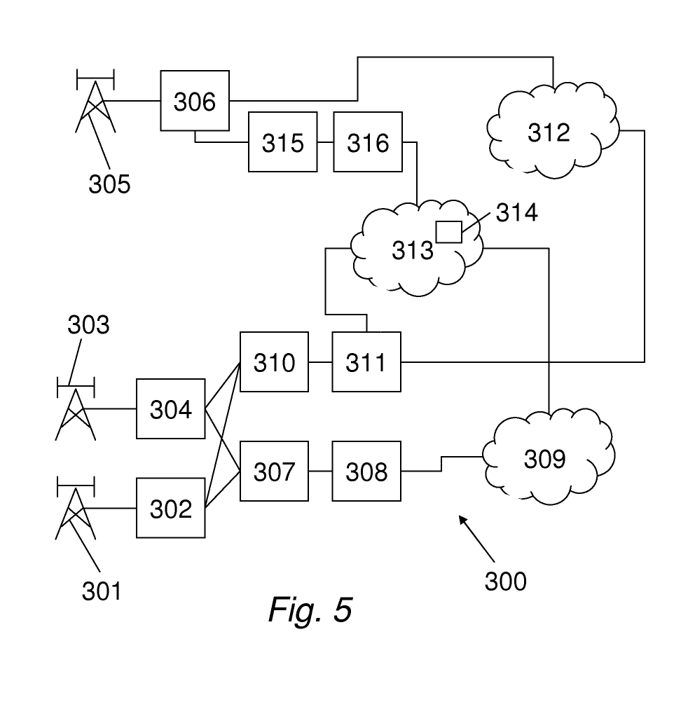

FIG. 5 shows a communications network 300 in an example embodiment. In this example, the network 300 includes various mechanisms by which the mobile communications device 101 may obtain access to services. In particular, the network may include a GSM base station 301 and a Radio Network Controller (RNC) 302. In this example, the GSM base station 301 provides a 2G/2.5G radio interface for legacy mobile devices. The GSM base station 301 may be one of a plurality of such base stations, for example. In this example, the network 300 also includes a Node B 303 and a further RNC 304 which together form the UTRAN (USTM Terrestrial Radio Access Network). In this example, the Node B 303 provides a 3G radio interface. Both of these radio interfaces may handle packet switched and circuit switched connections, as will be described in an example below.

In the above example, the above noted access points may be mobile telephone communications access points. In this example, the network includes a WLAN 305 and an access router 306. In this example, the WLAN 305 provides a WLAN “hotspot” using technology standards such as IEEE 802.11g (WiFi™). The WLAN 305 may handles PS connections.

In an example embodiment, the communications network 300 includes a CS domain and a PS domain. In this example, the CS domain includes an MSC (Mobile Switching Centre) 307 and a GMSC (Gateway MSC) 308. In this example, the CS domain is connected to the RNCs 302 and 304 as well as to a PSTN (Public Switched Telephone Network) 309. In this example, 2G or 3G CS voice calls may be established over the CS domain.

In an example embodiment, the PS domain includes a SGSN (Serving GPRS Support Node) 310 and a GGSN (Gateway GPRS Support Node) 311. In this example, the SGSN 310 is connected to the RNCs 302 and 304 and is the point through which PS data connections are made. The GGSN 311 is also connected to the Internet 312.

In addition to the above examples, the PS domain may also include an IMS (IP Multimedia Subsystem) 313. In this example, the IMS 313 includes a Media GateWay (MGW) 314, amongst other components, through which it forms a connection with the PSTN 309. In this example, The GGSN (Gateway GPRS Support Node) 311 is also connected to the IMS 313. In this example, the IMS 313 enables mobile devices to place VoIP calls, via the PS domain, directly to the PSTN 309.

In an example embodiment, the access router 306 is connected directly to the Internet 312. In an example embodiment, the access router is connected to the PS domain of the mobile telephone network. For example, the access router 306 may be connected to a WAG (Wireless Access Gateway) 315 which is the point of entry in to the PS domain of the mobile telephone network. In this example, the WAG 315 is connected to a PDG (Packet Data Gateway) 316. In this example, the PDG 316 is connected to the IMS 313.

As can be seen in the above examples, the communications network provides various radio interfaces which can be used by mobile communications devices to connect to either the Internet 312 or the PSTN 309, for example. Furthermore, these connections may be established over the CS domain or the PS domain. As discussed in the above examples, as a mobile device changes location, or as network conditions change, an active session may have to be transferred from one domain to another. An example of the technical requirements for such a transfer are laid out in 3GPP Technical Specification 23.206: “VCC between CS and IMS; Stage 2”. In this example, the mobile computing device 101 described above is arranged to enable such a transfer using the features described above. In this example, the IMS includes a VCC application (not shown).

The operation of the mobile communications device 101, in an example embodiment, will now be described.

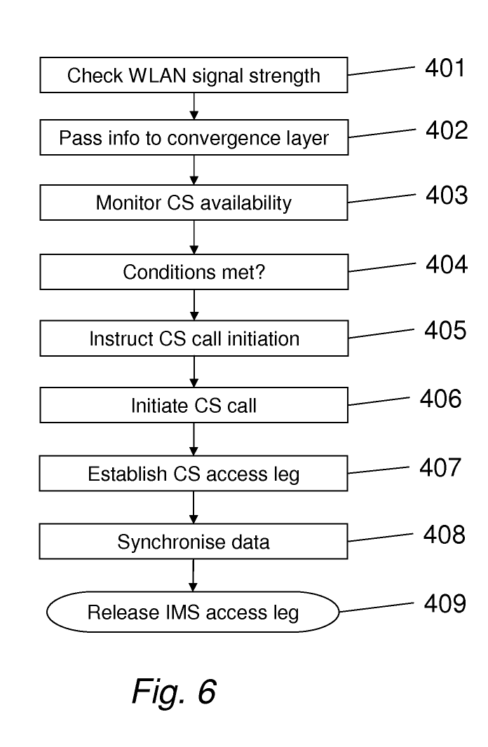

FIG. 6 is a flow diagram showing the transfer of a voice call from the IMS domain to the CS domain, in an example embodiment. In this example, a PS voice call has been initiated by the mobile communications handset 101. In this example, the PS voice call has been established via WLAN 305. In this example, the pre-stored polices and profiles state that, when a WLAN network connection is available, the mobile device 101 establishes an IMS connection rather than using a CS connection, which may also be available via a 2.5/3G base station.

In this example, the pre-stored profiles also state that, when the WLAN signal strength drops below a predetermined level, the mobile device should transfer the voice call to the CS domain, assuming a CS connection is available. In this example, the IMS management node 222 is continuously monitoring the WLAN signal strength, as well as the availability of the IMS via the WLAN 305 (block 401). In this example, this information is passed to the convergence management node 208 (block 402). In this example, the CS management node 219 simultaneously monitors the availability of circuit switched network connections via Node B 303 (block 403). In this example, CS network availability information is also reported to the VCC convergence management node 208.

In this example, when the convergence management node 208 determines that: a) the WLAN signal strength has dropped below a predetermined level; and b) a CS connection is available (block 404), the convergence management node 208 instructs the CS management node 219 to initiate a CS voice call (block 405). In this example, the convergence management node 208 passes details of the destination address to the CS management node 219. In this example, the CS management node 219 instructs the CS control node 217, which in turn instructs the session control node 216 to establish a CS connection to the destination address (block 406). In this example, the network then establishes an access leg in the CS domain to the destination device (block 407). In this example, once the CS access leg is established, the convergence control node 207 notifies the multimedia framework of the handover to allow it to synchronise the PS audio data with the CS audio data (block 408) as at this time both audio streams need to flow simultaneously. In this example, once synchronised, the convergence management node 208 instructs the IMS management node to release the IMS access leg (block 409). In this example, this will also release the IMS audio data.

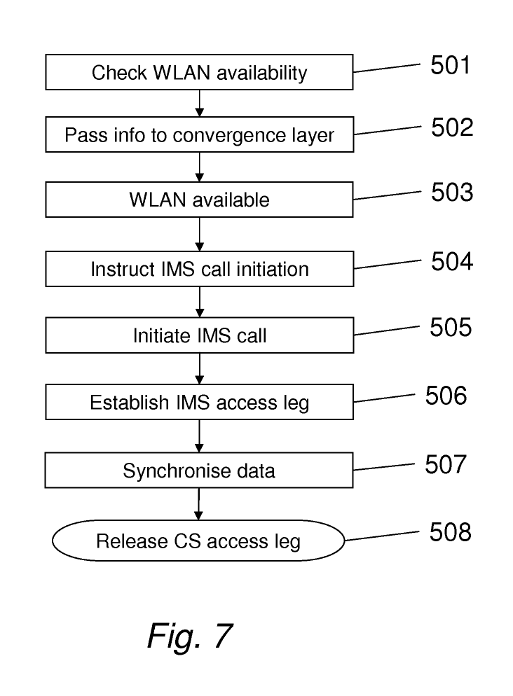

FIG. 7 is a flow diagram showing the transfer of a voice call from the CS domain to the IMS domain, in an example embodiment. In this example, a CS voice call has been initiated by the mobile communications handset 101. In this example, the CS voice call has been established via Node B 303. In this example, the pre-stored polices and profiles dictate that when no WLAN network connection is available, the mobile device 101 should establish a CS connection.

In this example, the pre-stored profiles also dictate that, when a WLAN is detected, having a signal strength above a predetermined level, the mobile device 101 should transfer the voice call to the IMS domain. In this example, the IMS management node 222 is constantly checking for the availability of WLANs and the WLAN signal strength, as well as the availability of the IMS via the WLAN (block 501). In this example, this information is passed to the VCC convergence management node 208 (block 502).

In this example, when the convergence management node 208 determines that a WLAN is available with sufficient signal strength (block 503), the convergence management node 208 instructs the IMS management node 222 to initiate an PS voice call (block 504) over WLAN. In this example, the convergence management node 208 passes details of the destination address to the IMS management node 222. In this example, the IMS management node 222 instructs the IMS control node 221, which in turn instructs the IMS session control node 220 to establish a IMS connection to the destination address (block 505). In this example, the network then establishes an access leg in the IMS domain to the destination device (block 506). In this example, once the IMS access leg is established, the convergence data node 211 synchronises the PS audio data with the CS audio data (block 507) as at this time both audio streams need to flow simultaneously. In this example, once synchronised, the convergence management node 208 instructs the CS management node 219 to release the CS access leg (block 508). In this example, this will also release the CS audio data.

It will be appreciated that these algorithms are just two examples of a number that may be implemented. In the above examples, WLAN could be replaced with a PS 3G bearer to provide mobility between the CS GSM/WCDMA and PS 3G bearers. In this example, the pre-stored profiles and polices may be used to implement a number of complex alternatives.

At least some of the above described examples provide the following advantages over the prior art. For example, by integrating the voice call continuity decision making in to the communications framework, users are not required to install additional software to handle VCC. In this example, this reduces the over-head generated in providing VCC functionality. In this example, the framework provides a bearer agnostic interface which relieves voice call clients of the burden of having to understand the underlying technology implementation.

A communications framework, in the context of examples of the present invention, is the part of the operating system which handles all communications to and from the device. In an example embodiment, it is the communications framework which handles domain transfer. In this example, it does this by monitoring lower layers in the CS and PS domains, and by making decisions based on bearer availability reported by the lower layers and pre-stored policy information. In this example, the term distinguishes examples of the present invention from third party applications which may sit in user space on top of the communications stack. Certain voice call clients may have to implement its own VCC mechanism. At least some of the above described examples avoid the need for separate implementations for each client.

In an example embodiment, the convergence architecture used for VCC can also be used to provide SMS convergence by allowing SMS messages to be sent either over the CS GSM/WCDMA bearer or over the IP IMS bearer (i.e. over the SIP protocol).

In an example embodiment, the telephone convergence APIs may be arranged so that a client can specify which domain it would like to connect through, overriding any pre-stored profiles or polices. In this example, applications may be notified by the VCC framework when any domain transfer takes place. In this example, applications may be allowed access to the pre-stored profiles in order for such an application to modify the profiles, if the application has the necessary security capabilities.

In an example of the invention, one of the benefits of enabling a user to access the PSTN via both 3G Node Bs and WLAN access points, is that service coverage can be offered when one or other of the access points is unavailable. For example, in large buildings, 3G coverage may be weak or intermittent. In this example, if the building is fitted with WLAN access points, then voice call coverage can still be offered.

An advantage of at least one example of the invention is that call establishment and call transfer is handled within the communications framework of the operating system. In this example, this dispenses with the need for applications to implement and handle VCC individually. In this example, the implementation is left to the underlying framework.

Examples of the present invention may be implemented in software, hardware, application logic or a combination of software, hardware and application logic. The software, application logic and/or hardware may reside on an individual component, computer chip or other computing apparatus. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 1. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

Various modifications, changes, and/or alterations may be made to the above described examples to provide further examples which use the underlying inventive concept, falling within the spirit and/or scope of the invention. Any such further examples are intended to be encompassed by the appended claims.

1. An apparatus comprising:
at least one processor; and
at least one memory including computer program code, wherein
the at least one memory and the computer program code are configured to, with the at least one processor, cause the apparatus to:
establish a communications framework, the communications framework being configured to establish connections to at least one communications network; wherein
the communications framework comprises a voice call continuity layer configured to decide whether to establish voice calls over a circuit switched part of said at least one communications network or a packet switched part of said at least one communications network and being configured to decide when to transfer a voice call from one part of the network to another part, wherein
said voice call continuity layer being further configured to make said decisions based on at least one of network availability information and pre-stored preferences.

2. An apparatus according to claim 1, wherein said communications framework further comprises a packet switched communication layer configured to monitor the availability of the packet switched part of the at least one communications network and to report network availability information to the voice call continuity layer.

3. An apparatus according to claim 1, wherein said communications framework further comprises a circuit switched communication layer configured to monitor the availability of the circuit switched part of the at least one communications network and to report availability information to the voice call continuity layer.

4. An apparatus according to claim 1, wherein each layer of the communications framework includes a data plane, configured to transport data, a control plane, configured control connections, and a management plane, configured to make decisions.

5. An apparatus according to claim 4, wherein each layer of said communications framework includes a data entity, in said data plane, at least one control entity, in said control plane, and a management entity, in said management plane.

6. An apparatus according to claim 5, wherein said voice call continuity layer management entity is configured to make decisions based on said communication network availability information received from said packet switched and circuit switched communications layers.

7. An apparatus according to claim 6, wherein the voice call continuity layer at least one control entity is configured to control connections to said at least one network.

8. An apparatus according to claim 7, wherein said control entity comprises a main control entity configured to control connections to said at least one network, and a session control entity, configured to control individual voice sessions.

9. An apparatus according to claim 5, wherein said voice call continuity layer data entity in said data plane is configured to synchronise packet switched and circuit switched audio data during call transfer.

10. An apparatus according to claim 5, wherein said circuit switched and packet switched layer management entities are configured to report the availability of their respective parts of said at least one communications network to said voice call continuity layer management entity.

11. An apparatus according to claim 5, wherein said voice call continuity layer management entity is further configured to inform said at least one voice call continuity layer control entity of said decisions.

12. An apparatus according to claim 5, wherein said communications framework includes a data store for storing said preferences and said voice call continuity layer management entity is further configured to make said decisions based on said preferences.

13-16. (canceled)

17. An apparatus according to claim 1, wherein said pre-stored preferences include information relating to radio connection availability and signal strengths.

18. A method comprising:
initiating a voice call;
deciding whether to establish the voice call in a circuit switched part of at least one communications network or a packet switched part of said at least one communications network, based on at least one of network availability and pre-stored preferences; and
establishing a voice call according to said decision; wherein
said decision is made by a voice call continuity layer which is part of a communications framework, the framework configured to establish connections to said at least one communications network.

19. A method comprising:
monitoring the availability of circuit switched and packet switched parts of at least one communications networks when a voice call is active;
determining when pre-stored call transfer parameters are met; and
causing said voice call to be transferred from the circuit switched to the packet switched network, or from the packet switched network to the circuit switched network; wherein
monitoring availability is done by a communications framework, the framework configured to establish connections to said at least one communications network, and
determining when pre-stored call transfer parameters are met is done by a voice call continuity layer, which is part of said communications framework.

20. A method according to claim 18, wherein said communications framework includes a packet switched communication layer and a circuit switched communication layer, the method further comprising:
the packet switched communication layer monitoring the availability of the packet switched part of the at least one communications network and reporting network availability information to the voice call continuity layer; and
the circuit switched communication layer monitoring the availability of the circuit switched part of the at least one communications network and reporting availability information to the voice call continuity layer.

21. A method according to claim 20, wherein the voice call continuity layer includes a management entity, the method further comprising:
the management entity making said decisions based on said network availability information received from said packet switched and circuit switched communications layers.

22. A method according to claim 21, wherein said communications framework includes a data store for storing preferences, the method further comprising:
the management entity making said decisions based on said preferences.

23. A method according to claim 22, wherein said voice call layer includes a data flow entity, the method further comprising:
the data flow entity synchronising packet switched and circuit switched audio data during call transfer.

24-28. (canceled)

29. A computer-readable medium encoded with instructions that, when executed by a computer, perform the method of claim 18.

30-31. (canceled)
